(19) United States
(12) Patent Application Publication
(10) Pub. No.: US 2015/0184826 A1
(43) Pub. Date: Jul. 2, 2015

(54) LIGHT EMITTING DEVICE AND BACKLIGHT MODULE EMPLOYING SAME

(71) Applicant: HON HAI PRECISION INDUSTRY CO., LTD., New Taipei (TW)

(72) Inventors: CHAU-JIN HU, Tu-Cheng (TW); FENG-YUEN DAI, Tu-Cheng (TW); PO-CHOU CHEN, Tu-Cheng (TW)

(21) Appl. No.: 14/551,717

(22) Filed: Nov. 24, 2014

(30) Foreign Application Priority Data
Dec. 26, 2013 (TW) 102148427

(51) Int. Cl. F21V 5/00; F21V 23/00; F21V 17/10; F21V 5/04; F21V 17/08

(52) U.S. Cl. CPC F21V 5/008; F21V 5/048; F21V 17/08; F21V 17/10; F21V 23/005

(57) ABSTRACT

A light emitting device includes a light source located at a central axis, a light diverging unit, and a circuit board. The light diverging unit includes a first light diverging part comprising a light incident surface facing to the light source, a second light diverging part, and a third light diverging part comprising a light emitting surface. The circuit board carries the light source and the light diverging unit. Light emitted by the light source is transmitted through the first light diverging part, the second light diverging part, and the third light diverging part in sequence, and a refraction index of the second light diverging part is smaller than that of the first and third light diverging parts.

### FIELD

The present disclosure relates to a light emitting device and a backlight module employing the light emitting device.

### BACKGROUND

A backlight module usually includes a light source and a light diffusion lens for diffusing the light emitted by the light source. Most of the light emitted by the light source is diffused by the light diffusion lens. The remainder of the light is reflected when emitted from the light diffusion lens.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross sectional view of a light emitting device according to a first embodiment of the present disclosure.

FIG. 2 is a cross sectional, exploded view of the light emitting device of FIG. 1.

FIG. 3 is a cross sectional view of a light emitting device according to a second embodiment of the present disclosure.

FIG. 4 is a cross sectional, exploded view of the light emitting device of FIG. 3.

FIG. 5 is a diagram showing the relationship between a light intensity and a emergence angle of light.

FIG. 6 is a cross sectional view of a back light module according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to a light emitting device and a backlight module including the light emitting device.

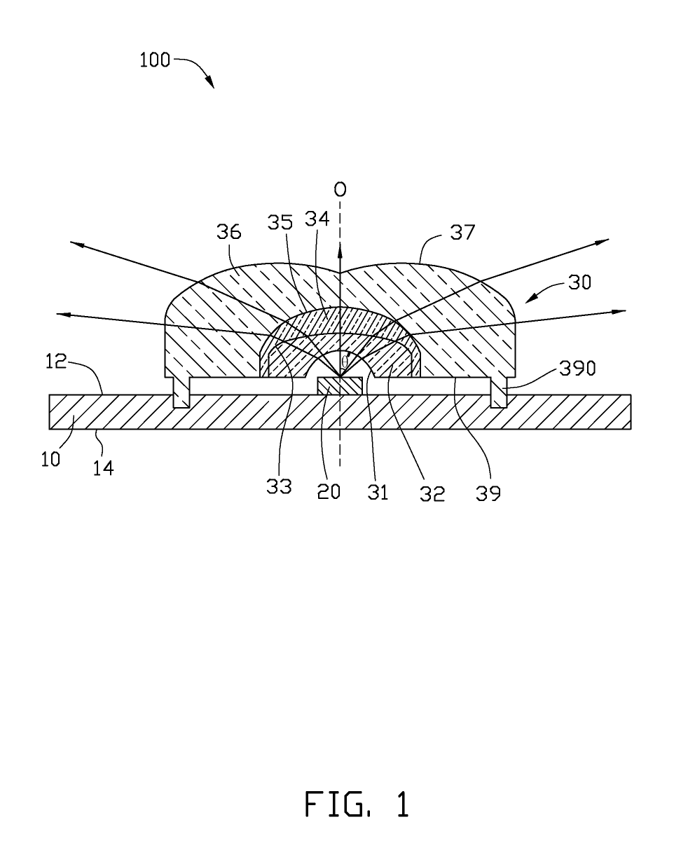

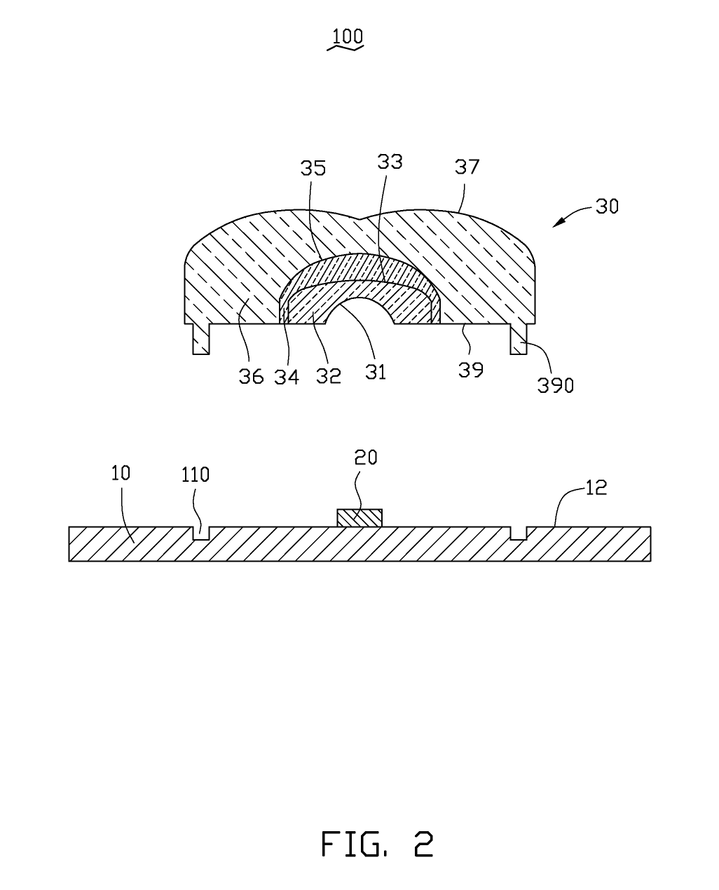

FIGS. 1 and 2 illustrate a light emitting device 100 including a circuit board 10, a light source 20 and a light diverging unit 30.

The circuit board 10 includes a first surface 12 and a second surface 14 opposite to the first surface 12. The light source 20 and the light diverging unit 30 are mounted on the first surface 12. The light source 20 is located at a central axis 0.

In this embodiment, the light source 20 is a light emitting diode (LED). Light emitted by the light source 20 is in a Lambertian distribution. That is, the brightness of the light is substantially uniform along different directions, and the intensity of the light is proportional to cosθ′, wherein θ′ is an included angle between the direction of the light and a normal direction of a light emitting surface of the light source 20. The light is then scattered by the light diverging unit 30.

The light diverging unit 30 includes a first light diverging part 32, a second light diverging part 34, and a third light diverging part 36 stacked in sequence.

The light diverging unit 30 is symmetrical about the central axis O. The first light diverging part 32 includes a light incident surface 31 facing the light source 20. The light diverging unit 30 includes a first boundary surface 33 between the first light diverging part 32 and the second light diverging part 34, and a second boundary surface 35 between the second light diverging part 34 and the third light diverging part 36. The third light diverging part 36 includes a light emitting surface 37 opposite to the second boundary surface 35. The first, second and third light diverging parts 32, 34, 36 cooperatively include a bottom surface 39 facing the circuit board 10 and are connected between the light incident surface 31 and the light emitting surface 37.

The light incident surface 31 and the second boundary surface 35 are curved surfaces, bulging away from the light source 20. A curvature radius of the second boundary surface 35 is larger than that of the light incident surface 31. The first boundary surface 33 and the light emitting surface 37 are aspheric surfaces. The first boundary surface 33 and the second boundary surface 35 are connected to the bottom surface 39.

The first light diverging part 32, the second light diverging part 34 and the third light diverging part 36 are made of transparent resin. A refraction index of the second light diverging part 34 is smaller than that of the first light diverging part 32. The refraction index of the second light diverging part 34 is smaller than that of the third light diverging part 36.

The light emitting device 100 further includes two pins 390 projecting from the bottom surface 39, and the circuit board 10 further defines two holes 110 in the first surface 12. The pins 390 are inserted into the holes 110 to mount the light diverging unit 30 on the circuit board 10.

When operating, light emitted by the light source 20 enters the light diverging unit 30 from the light incident surface 31, transmits through the first boundary surface 33 and the second boundary surface 35, and is emitted from the light emitting surface 37.

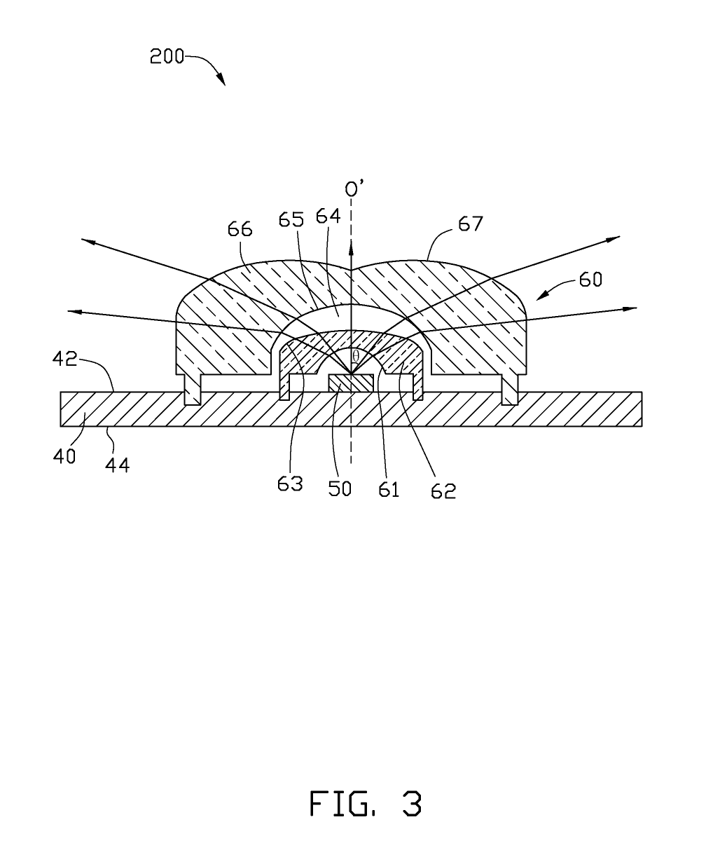

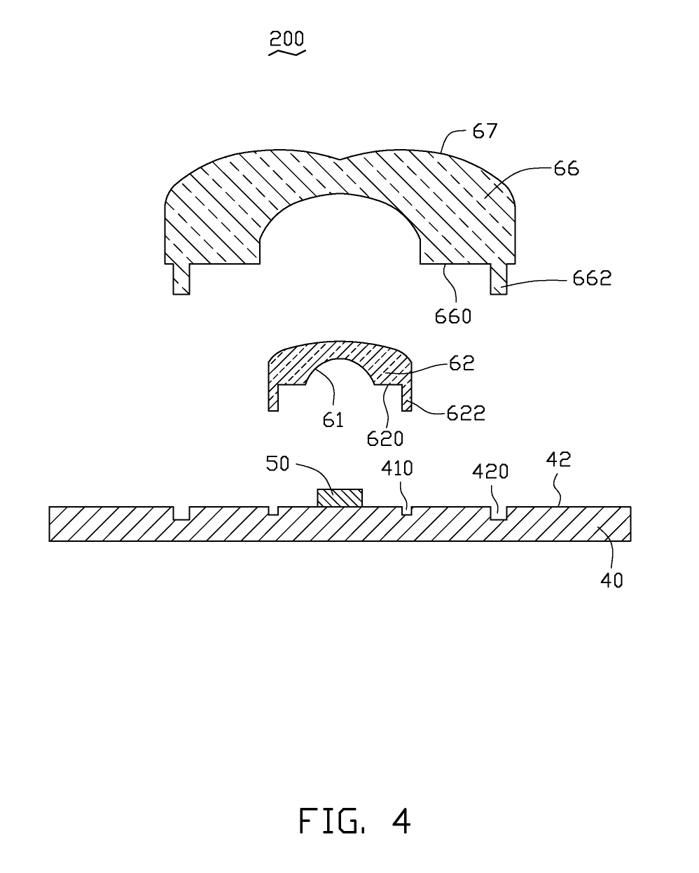

FIGS. 3 and 4 illustrate a light emitting device 200 including a circuit board 40, a light source 50 and a light diverging unit 60.

The circuit board 40 includes a first surface 42 and a second surface 44 opposite to the first surface 42. The light source 50 and the light diverging unit 60 are mounted on the first surface 42. The light source 50 is located at a central axis O′.

In this embodiment, the light source 50 is a light emitting diode (LED). Light emitted by the light source 50 is a Lambertian distribution. That is, the brightness of the light is substantially uniform along different directions, and the intensity of the light is proportional to cosθ, wherein θ is an included angle between the direction of the light and a normal direction of a light emitting surface of the light source 50. The light is then scattered by the light diverging unit 60.

The light diverging unit 60 includes a first light diverging part 62, a second light diverging part 64, and a third light diverging part 66 stacked in sequence.

The light diverging unit 60 is symmetrical about the central axis O′. The first light diverging part 62 includes a light incident surface 61 facing the light source 50. The light diverging unit 60 includes a first boundary surface 63 between the first light diverging part 62 and the second light diverging part 64, and a second boundary surface 65 between the second light diverging part 64 and the third light diverging part 66. The third light diverging part 66 includes a light emitting surface 67 opposite to the second boundary surface 65. The first light diverging part 62 includes a first bottom surface 620 facing the circuit board 40 and connected between the light incident surface 61 and the first boundary surface 63. The third light diverging part 66 includes a second bottom surface 660 facing the circuit board 40 and connected between the light emitting surface 67 and the second boundary surface 65. The first bottom surface 620 is even with the second bottom surface 660.

The light incident surface 61 and the second boundary surface 65 are curved surfaces, bulging away from the light source 50. A curvature radius of the second boundary surface 65 is larger than that of the light incident surface 61. The first boundary surface 63 and the light emitting surface 67 are aspheric surfaces.

The first light diverging part 62 and the third light diverging part 66 are made of transparent resin. The second light diverging part 64 is full of air. A refraction index of the second light diverging part 64 is smaller than that of the first light diverging part 62. The refraction index of the second light diverging part 64 is smaller than that of the third light diverging part 66.

The first light diverging part 62 further includes two first pins 622 projecting from the first bottom surface 620, and the third light diverging part 66 further includes two second pins 662 projecting from the second bottom surface 660. The circuit board 40 further defines two first holes 410 and two second holes 420 in the first surface 42. The first pins 622 are inserted into the first holes 410 to mount the first light diverging part 62 on the circuit board 40. The second pins 662 are inserted into the second holes 420 to mount the third light diverging part 66 on the circuit board 40.

When operating, light emitted by the light source 50 enters the light diverging unit 60 from the light incident surface 61, transmits through the first boundary surface 63 and the second boundary surface 65, and emits from the light emitting surface 67.

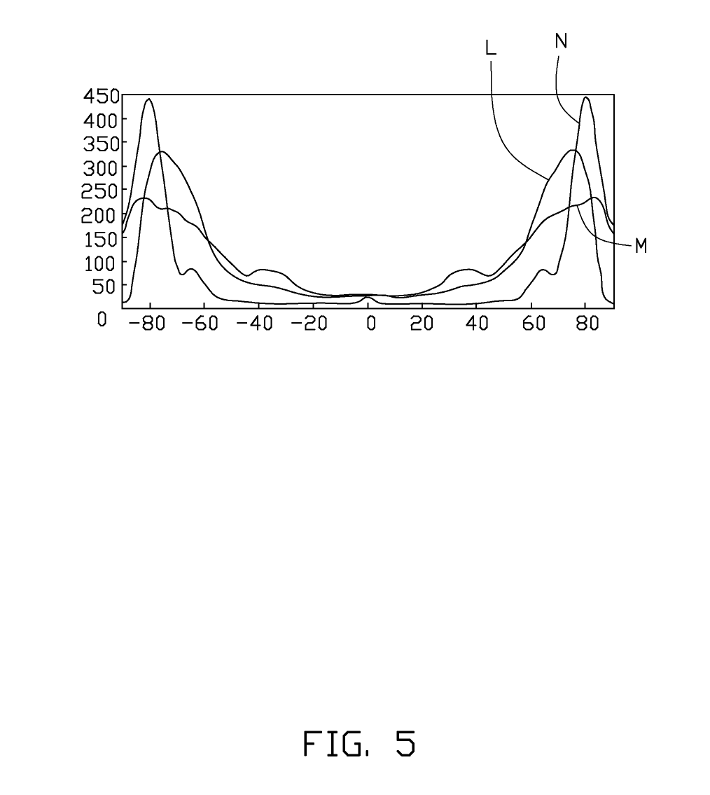

FIG. 5 illustrates line L and the relationship between a light intensity and an emergence angle of light emitted from a prior art light emitting device. Line M illustrates the relationship between a light intensity and an emergence angle of light emitted from the first boundary surface 63. Line N illustrates the relationship between a light intensity and an emergence angle of light emitted from the light emitting surface 67. FIG. 5 illustrates that a divergent angle of the light emitting device 200 is substantially equal to that of the prior art light emitting device, but a light intensity of the light emitting device 200 at the biggest emergence angle is slightly bigger than that of the prior art light emitting device. Thus, the light emitting device 200 can increase the light intensity relative to the prior art light emitting device.

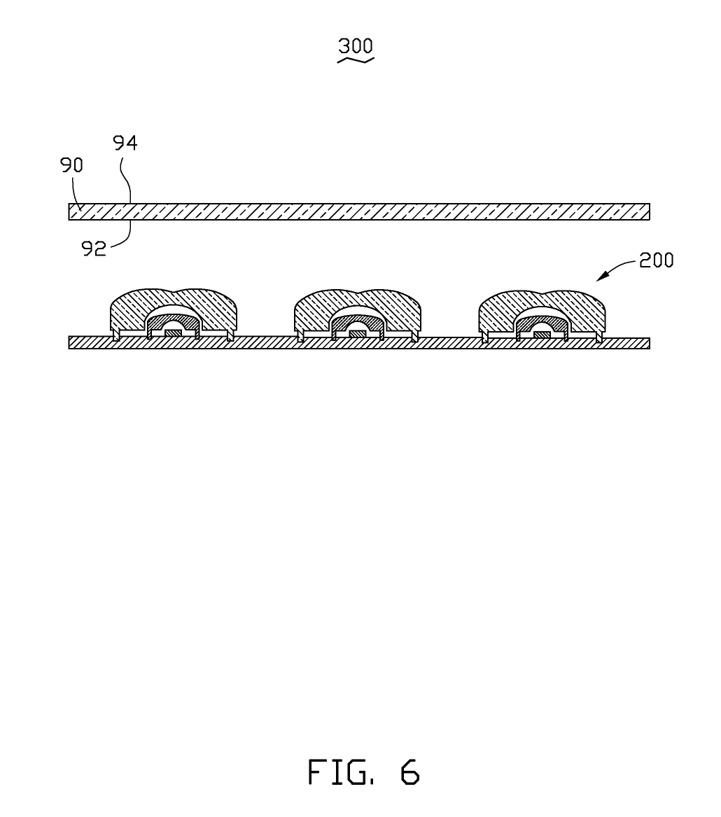

FIG. 6 illustrates that a backlight module 300 can include a plurality of light emitting devices 200 and a light diffusion board 90.

The light diffusion board 90 includes a light incident surface 92 and a light emitting surface 94 opposite to and parallel to the light incident surface 92. The light incident surface 92 is adjacent to the light emitting devices 200. Light emitted by the light emitting devices 200 is further scattered by the light diffusion board 90.

In other embodiments, the backlight module 300 can use the light emitting device 100 to replace the light emitting device 200.

It will be understood that the above particular embodiments are shown and described by way of illustration only. The principles and the features of the present disclosure can be employed in various and numerous embodiments thereof without departing from the scope of the disclosure. The above-described embodiments illustrate the scope of the disclosure but do not restrict the scope of the disclosure.

What is claimed is:

1. A light emitting device comprising:
a light source located at a central axis;
a light diverging unit comprising:
a first light diverging part comprising a light incident surface facing to the light source;
a second light diverging part; and
a third light diverging part comprising a light emitting surface; and
a circuit board carrying the light source and the light diverging unit;
wherein light emitted by the light source is transmitted through the first light diverging part, the second light diverging part, and the third light diverging part in sequence, and a refraction index of the second light diverging part is smaller than that of the first and third light diverging parts.

2. The light emitting device of claim 1, wherein the first light diverging part, the second light diverging part, and the third light diverging part are all symmetrical about the central axis.

3. The light emitting device of claim 1, wherein the light source is a light emitting diode.

4. The light emitting device of claim 1, wherein the light diverging unit further comprises a first boundary surface between the first light diverging part and the second light diverging part, and a second boundary surface between the second light diverging part and the third light diverging part, the first boundary surface and the second boundary surface are curved surfaces, light emitted by the light source is transmitted through the light incident surface, the first boundary surface, the second boundary surface and the light emitting surface in sequence.

5. The light emitting device of claim 4, wherein a curvature radius of the second boundary surface is larger than that of the light incident surface, and the first boundary surface and the light emitting surface are aspheric surfaces.

6. The light emitting device of claim 1, wherein the second light diverging part is empty and full of air.

7. The light emitting device of claim 1, wherein the light diverging unit comprises pins, and the circuit board defines holes, the pins are inserted into the holes to mount the light diverging unit on the circuit board.

8. A backlight module comprising:
a light emitting device comprising:
a light source located at a central axis;
a light diverging unit comprising:
a first light diverging part comprising a light incident surface facing to the light source;
a second light diverging part; and
a third light diverging part comprising:
a light emitting surface; and
a circuit board carrying the light source and the light diverging unit; and
a light diffusion board aligned with the light emitting device;
wherein light emitted by the light source is transmitted through the first light diverging part, the second light diverging part, and the third light diverging part in sequence, and a refraction index of the second light diverging part is smaller than that of the first and third light diverging parts.

9. The backlight module of claim 8, wherein the first light diverging part, the second light diverging part, and the third light diverging part are all symmetrical about the central axis.

10. The backlight module of claim 8, wherein the light source is a light emitting diode.

11. The backlight module of claim 8, wherein the light diverging unit further comprises a first boundary surface between the first light diverging part and the second light diverging part, and a second boundary surface between the second light diverging part and the third light diverging part, the first boundary surface and the second boundary surface are curved surfaces, light emitted by the light source is transmitted through the light incident surface, the first boundary surface, the second boundary surface and the light emitting surface in sequence.

12. The backlight module of claim 11, wherein a curvature radius of the second boundary surface is larger than that of the light incident surface, and the first boundary surface and the light emitting surface are aspheric surfaces.

13. The backlight module of claim 8, wherein the second light diverging part is empty and full of air.

14. The backlight module of claim 8, wherein the light diverging unit comprises pins, and the circuit board defines holes, the pins are inserted into the holes to mount the light diverging unit on the circuit board.
